(19) United States
(12) Patent Application Publication
(10) Pub. No.: US 2009/0045032 A1
(43) Pub. Date: Feb. 19, 2009

(54) DEVICE FOR SORTING DISK BODIES

(75) Inventors: Ryoji Yamagishi, Saitama (JP); Yasuyuki Furusawa, Saitama (JP)

Correspondence Address: FISH & RICHARDSON P.C., P.O. BOX 1022, MINNEAPOLIS, MN, 55440-1022, US

(73) Assignee: KABUSHIKI KAISHA NIPPON CONLUX, Saitama (JP)

(21) Appl. No.: 12/093,219

(22) PCT Filed: Feb. 16, 2007
(86) PCT No.: PCT/JP2007/052855

§ 371 Date: May 9, 2008

(30) Foreign Application Priority Data
Mar. 22, 2006 (JP) 2006-079028

(51) Int. Cl. G07F 1/04; G07D 5/02

(52) U.S. Cl. 194/344

(57) ABSTRACT

[Problems] To provide a device for sorting disk bodies, where workability in maintenance and check, including cleaning etc., of a disk body guide passage is further improved and accuracy of sorting disk bodies is further enhanced.

[Means for Solving the Problems] A gate plate biasing means is disposed at plural positions to apply a biasing force to a gate plate (3) in a direction to close a main plate (2) while the gate plate (3) is reaching a predetermined turning angle about a shaft (8) and to apply a biasing force to the gate plate (3) in a direction to open the main plate (2) when the gate plate (3) is turned by the predetermined turning angle or more.

### TECHNICAL FIELD

The present invention relates to an improvement of a device for sorting disk bodies which determines whether a disk body such as a coin, a token or a medal for gameplay is genuine or not, and sorts it.

### BACKGROUND ART

Game machines such as slot machines are conventionally provided with a disk body sorting device which determines whether a disk body (a coin, a medal for gameplay or the like) dropped into a disk body slot is genuine or not and accommodates the disk body when it is determined as an authentic disk body and ejects the disk body when it is determined as a counterfeit disk body.

This disk body sorting device is provided with a disk body discrimination means for determining whether the inserted disk body is genuine or not, and a disk body guide passage for guiding the inserted disk body to the disk body discrimination means.

The disk body discrimination means is disposed on a main plate which is a main component element of the disk body sorting device, and the disk body guide passage for guiding the inserted disk body to the disk body discrimination means is configured of a side wall of the main plate and a side wall of a gate plate which covers the side wall of the main plate. At the time of maintenance and check, the gate plate is opened from the main plate to open up the disk body discrimination means and the disk body guide passage.

Meanwhile, the above-described gate plate is biased to close the surface of the main plate at all times by a biasing force of a special spring (deformed double torsion spring) which is inserted into a shaft which rotatably supports the gate plate as described in, for example, JP-A 2001-155206 previously filed by the present applicant.

### [Patent Literature 1] JP-A 2001-155206

### SUMMARY OF THE INVENTION

### Problems to be Solved by the Invention

In a case where an operator opens the above-described disk body guide passage of the disk body sorting device to perform maintenance and check work such as cleaning, it is necessary to maintain the gate plate in an open state to the main plate.

However, since the conventional gate plate is always biased to close the surface of the main plate by the special spring (deformed double torsion spring) as described above, in order to keep the gate plate open, the operator needs to support the gate plate against the biasing force of the special spring such that the gate plate is not closed. Thus, there are disadvantages that the cleaning work is troublesome, and the maintenance and check workability is poor.

Where the conventional special spring (deformed double torsion spring) is used, the biasing force of the special spring does not keep pushing uniformly a gate plate-supporting shaft to bearings for supporting the shaft, so that when the gate plate is opened or closed, positioning accuracy of the gate plate with respect to the main plate lowers within a range of tolerance between the shaft and the bearings. Consequently, forming accuracy of the disk body guide passage formed between the main plate and the gate plate is deteriorated, and sorting accuracy of the disk body sorting device is considerably deteriorated as a result.

The assembly of the conventional biasing means (deformed double torsion spring) is troublesome, and it has a special structure, resulting in increasing the cost. In addition, where the main plate and the gate plate are mutually engaged at one position, the structure becomes complex because the gate is divided in order to restrict the position, resulting in increasing the cost.

The present invention has been made in view of the above circumstances and provides a disk body sorting device that the maintenance and check workability such as cleaning of the disk body guide passage and the sorting accuracy of the disk body are improved more.

### Means for Solving the Problems

To remedy the above-described problems, the present invention provides a disk body sorting device having a main plate and a gate plate which is supported rotatably about a shaft and covers openably the main plate, wherein a gate plate biasing means is disposed at plural positions to apply a biasing force to the gate plate in a direction to close the main plate while the gate plate is reaching a predetermined turning angle about the shaft and to apply a biasing force to the gate plate in a direction to open the main plate when the gate plate is turned by a predetermined turning angle or more.

### EFFECTS OF THE INVENTION

By virtue of the above-described gate plate biasing means, the biasing force acts on the gate plate in the direction to close the main plate while the gate plate is reaching the predetermined turning angle about the shaft, and the biasing force acts on the gate plate in the direction to open the main plate when the gate plate is turned by the predetermined turning angle or more, so that the biasing force for covering the main plate is kept applied to the gate plate while the turning angle of the gate plate is reaching the predetermined turning angle about the shaft. Thus, the gate plate securely covers the main plate to maintain its function without fail when the disk body sorting device is being used, and the gate plate biasing means applies the biasing force to the gate plate in a direction to open the main plate when the gate plate is opened by the predetermined turning angle or more to open up between the main plate and the gate plate at the time of the maintenance and check, so that the operator does not need to work to support the gate plate, and the workability of the maintenance and check can be improved considerably.

According to the invention, since the above-described gate plate biasing means is disposed at plural positions, the shaft for supporting the gate plate and the bearings for supporting it can be firmly attached by a uniform pressure at all times, so that the positioning accuracy of the gate plate with respect to the main plate is improved remarkably, forming accuracy of the disk body guide passage formed between the main plate and the gate plate is improved to additionally improve the disk body sorting accuracy, and assembling becomes easy. Thus, the disk body sorting device of which production cost is reduced can be provided.

### BEST MODE FOR CARRYING OUT THE INVENTION

The disk body sorting device according to the present invention is described in detail below.

FIG. 1 is a conceptual front view of ε disk body sorting device 1 according to the invention.

The disk body sorting device 1 is comprised of a rectangular main plate 2, which is made of a synthetic resin or the like such as plastic, and a gate plate 3 which openably covers substantially the upper side of the main plate 2 and is also made of a synthetic resin or the like such as plastic.

The gate plate 3 has three bearings 5, 6, 7 on the right side of its surface 4, and a shaft 8 is inserted through the bearings 5, 6, 7.

The shaft 8 rotatably supports the gate plate 3 to the main plate 2. A top end 8a of the shaft 8 is formed on the main plate 2, a bottom end 8b is formed on the gate plate 3, and they are rotatably inserted into bearings 9, 7 which have one end closed and have a cross-sectional semicircular shape. The intermediate part of the shaft 8 is also inserted through a bearing 11 which is formed on the main plate 2 and has a cross-sectional semicircular shape.

Top and bottom positions of the gate plate 3 are restricted by the bearings 9, 11 of the main plate 2 and the bearings 5, 6 of the gate plate 3.

A gate plate biasing means 20 of the invention which changes the direction of the biasing force to the gate plate 3 depending on a turning position of the gate plate 3 is disposed between an upper end 12 of the above-described gate plate 3 and an upper part 13 of the main plate 2 and between a lower end 14 of the gate plate 3 and a lower part 15 of the main plate 2. The gate plate positioning biasing means 20 will be described in detail later.

FIG. 2 is a perspective view showing a state that the gate plate 3 is opened to open up the main plate 2. The gate plate 3 is provided with a single inclined transfer rail 30 which configures a lower surface of a disk body guide passage A, and a notch 31 which sorts the disk body depending on the diameter is formed along the inclined transfer rail 30. The gate plate 3 is also provided with a cradle 33 which comes into contact with the disk body inserted into a disk body slot 32 and controls its drop velocity.

Meanwhile, the main plate 2 oscillatably supports a disk body pushing lever 34, which inclines the inserted disk body toward the notch 31 of the gate plate 3, at a downstream end of a disk body guide passage B which guides the disk body inserted into the disk body slot 32 to the upstream of the disk body guide passage A, and has a disk body restriction means 35 which is disposed in the approximate midstream of the disk body guide passage A and allows or prevents the passage of the inserted disk body. And, a disk body detection sensor 36 or the like for detecting the number of passed disk bodies is disposed downstream of the disk body guide passage A.

The above-described gate plate biasing means 20 is described in detail below.

FIG. 3 is a main portion fracture enlarged top view of the disk body sorting device 1, particularly showing in detail the above-described gate plate biasing means 20 (hereinafter simply referred to as the biasing means).

As shown in FIG. 3, the biasing means 20 is composed of a single tension spring 23 which is disposed under tension in engagement with a projection 21 which is protruded on the upper end 12 of the gate plate 3 and a notch 22 which is protruded on the upper portion 13 of the main plate 2. The tension spring 23 is composed of a coil spring 24 in the embodiment, and a hook part 24a of which leading end part is engaged with the projection 21 of the gate plate 3 is formed to be relatively long such that it passes through the upper end 12 of the gate plate 3, thereby preventing an occurrence of a problem in its pulling action because of the contact of a coil part 24b of the coil spring 24 with the upper end 12 of the gate plate 3.

Meanwhile, the relative positional relation of the above-described single tension spring 23, the shaft 8 which supports the gate plate 3, the projection 21 which is protruded on the upper end 12 of the gate plate 3 and the notch 22 which is protruded on the upper portion 13 of the main plate 2 is determined such that a force acts on the gate plate 3 counterclockwise about the shaft 8 for supporting the gate plate 3 at a closed position of the main plate 2 by the gate plate 3.

More specifically, an acting direction of a component force F1 of a tensile force F of the tension spring 23 is set to act counterclockwise on a line segment L which connects the shaft 8 and the projection 21 protruded from the upper end 12 of the gate plate 3. Thus, when the relative positional relation of the shaft 8, the projection 21 and the notch 22 is determined, the gate plate 3 at the position shown in FIG. 3 is biased to keep closing the main plate 2 by the component force F1 of the tension spring 23.

Meanwhile, it is determined that when the operator turns the gate plate 3 as indicated by arrow D about the shaft 8 against the biasing force of the gate plate 3 by the component force F1 of the above-described tension spring 23 to open the main plate 2 in order to perform the maintenance and check, the direction of the component force of the tension spring 23 about the shaft 8 against the gate plate 3 is varied at the periphery of an open position at a predetermined turning angle, namely about 90 degrees in the embodiment as shown in FIG. 4.

In further detail, a force clockwise about the shaft 8 which supports the gate plate 3 acts on the gate plate 3 at the open position of the gate plate 3 shown in FIG. 4. More specifically, the acting direction of a component force F2 of the tensile force F of the tension spring 23 acts clockwise on the line segment L which connects the shaft 8 and the projection 21 protruded on the upper end 12 of the gate plate 3. Thus, when the gate plate 3 is biased by the component force F2 of the tension spring 23 about the shaft 8 in a direction to keep the main plate 2 open, the gate plate 3 comes into contact with a stopper 40, which is protruded on the main plate 2, to stop its turning and is stopped to position at that position.

The point is, the above-described relative positional relation indicates that when the main plate 2 is covered with the gate plate 3 as shown in FIG. 3, the shaft 8 which rotatably supports the gate plate 3 is in position deviated from an extension direction line of the tension spring 23 which is engaged with the gate plate 3 and the main plate 2. In the above embodiment, the tension spring 23 is composed of the coil spring 24, but the present invention is not limited to the above embodiment, and the tension spring 23 may be composed of, for example, rubber or the like.

Therefore, when the gate plate 3 is opened for the maintenance and check to a predetermined turning angle position to open between the main plate 2 and the gate plate 3 by the above-described biasing means 20 as shown in FIG. 4, the gate plate biasing means 20 keeps applying a biasing force to the gate plate 3 in a direction to open up the main plate 2, so that the operator does not need to work to support the gate plate 3, and the workability of the maintenance and check is improved considerably.

In the above embodiment, the gate plate biasing means 20 is disposed on the upper and lower ends 12, 14 of the gate plate 3 to firmly attach the shaft 8, which supports the gate plate 3, and the individual bearings 5, 6, 7, 9, 10 which support it by a uniform pressure at all times, so that positioning accuracy of the gate plate 3 to the main plate 2 is improved considerably, and the forming accuracy of the disk body guide passage A which is formed between the main plate 2 and the gate plate 3 is improved. Thus, the disk body sorting device having higher disk body sorting accuracy can be provided.

In the above embodiment, the above-described gate plate biasing means 20 is disposed at two positions of the upper and lower ends 12, 14 of the gate plate 3, but the present invention is not limited to the above embodiment. In addition to the upper and lower ends 12, 14 of the gate plate 3, the gate plate biasing means 20 may also be disposed at an intermediate part between the upper and lower ends 12 and 14 and also at three positions or more between the upper and lower ends 12 and 14 of the gate plate 3. It is needless to say that the number of its disposition positions is not limited.

### INDUSTRIAL APPLICABILITY

The present invention is suitable to a disk body sorting device that maintenance and check workability for cleaning or the like of the disk body guide passage is improved more and disk body sorting accuracy is improved more.

### BRIEF DESCRIPTION OF THE DRAWINGS

FIG. 1 is a front view of a disk body sorting device according to the invention.

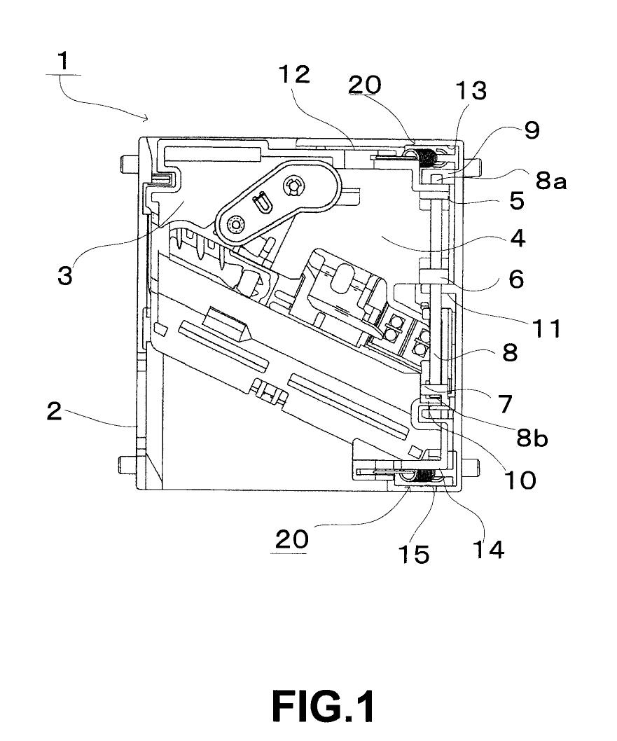

FIG. 2 is a perspective view of the disk body sorting device, showing a state that a gate plate is opened.

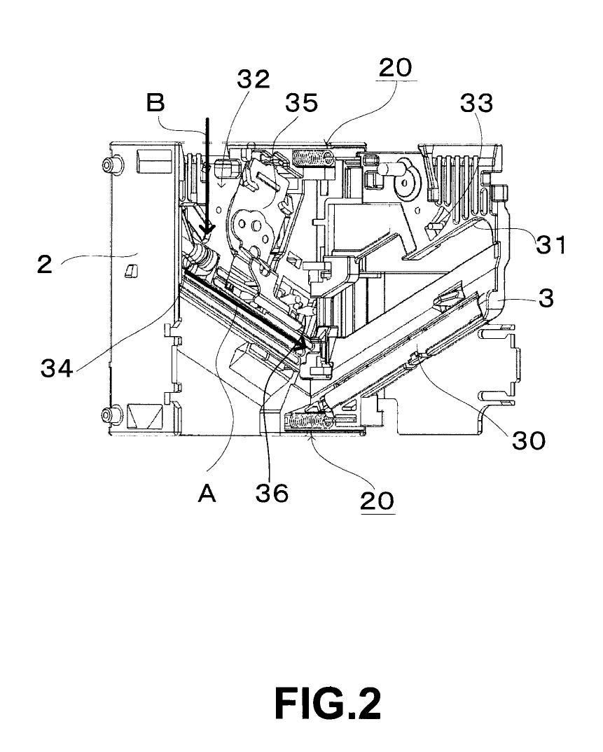

FIG. 3 is a main portion fracture enlarged top view showing an operation of the disk body sorting device according to the invention.

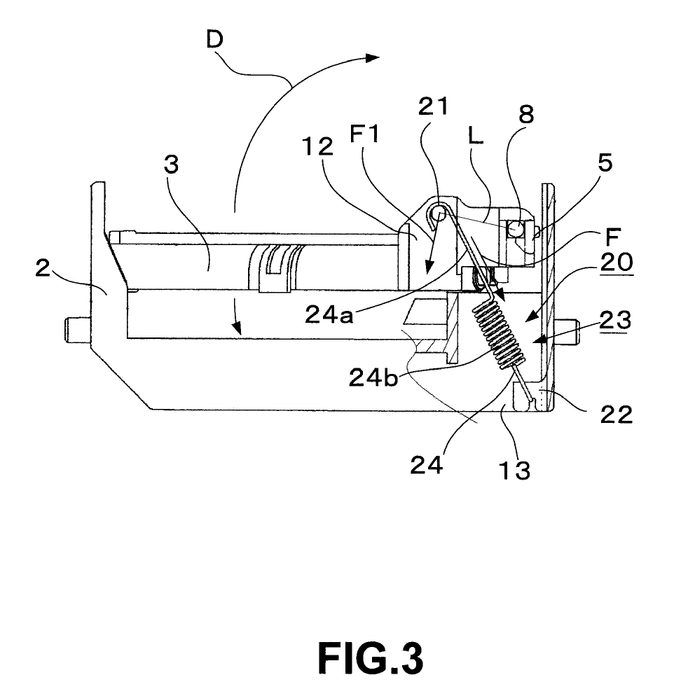

FIG. 4 is a main portion fracture enlarged top view showing an operation of the disk body sorting device according to the invention.

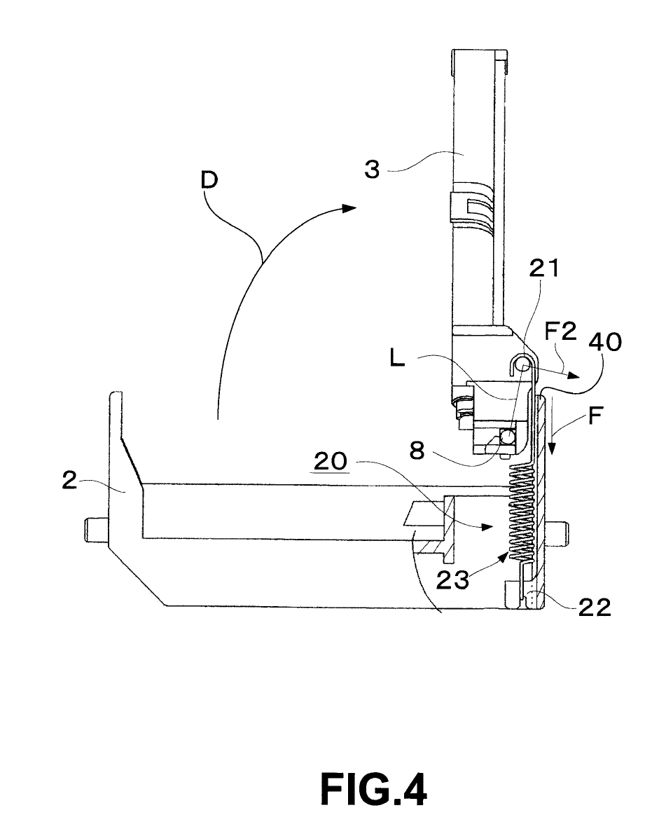

### DESCRIPTION OF THE REFERENCE NUMERALS

1: Disk body sorting device
2: Main plate
3: Gate plate
8: Shaft
12: Upper end
14: Lower end
20: Gate plate biasing means
23: Tension spring

1. A device for sorting a disk body, comprising a main plate and a gate plate which is supported rotatably about a shaft and covers openably the main plate, characterized in that a gate plate biasing means is disposed at plural positions to apply a biasing force to the gate plate in a direction to close the main plate while the gate plate is reaching a predetermined turning angle about the shaft and to apply a biasing force to the gate plate in a direction to open the main plate when the gate plate is turned by the predetermined turning angle or more.

2. The device for sorting a disk body according to claim 1, characterized in that the gate plate biasing means comprises a tension spring which is engaged with the gate plate and the main plate, and the shaft which rotatably supports the gate plate is in a position deviated from an extension direction line of the tension spring engaged with the gate plate and the main plate when the main plate is covered with the gate plate.

3. The device for sorting a disk body according to claim 1 or 2, characterized in that the gate plate biasing means is disposed at two positions of upper and lower ends of the gate plate.
